(19) United States
(12) Patent Application Publication
(10) Pub. No.: US 2010/0012411 A1
(43) Pub. Date: Jan. 21, 2010

(54) VEHICLE STORAGE COMPARTMENT

(75) Inventors: Stephen Fiacchino, Port Washington, WI (US); George Konstantakis, Franklin, WI (US); James Braun, Muskego, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 12/174,033

(22) Filed: Jul. 16, 2008

(51) Int. Cl. B60R 7/02

(52) U.S. Cl. 180/89.11; 296/37.1

(57) ABSTRACT

A storage compartment, configured to be supported by a vehicle frame, includes a body having an inner surface defining a cavity and an opening for access to the cavity, a door movable between an open position in which the door exposes the opening and a closed position in which the door covers the opening, and a hinge assembly coupling the door and the body. The hinge assembly is enclosed within the cavity when the door is in the closed position. The hinge assembly includes a first four-bar linkage mounted to the body and a second four-bar linkage mounted to the door. The first and second four-bar linkages have at least two unitary links in common.

### FIELD OF THE INVENTION

The present invention relates to vehicle storage compartments, and more particularly to hinge assemblies for vehicle storage compartments.

### BACKGROUND OF THE INVENTION

Saddlebags or other storage compartments are popular touring accessories that are often attached to motorcycles or other vehicles and utilized to store items. Saddlebags are often made from a flexible material (e.g., leather or another fabric) or a rigid, more durable material (e.g., plastic or fiberglass). Rigid saddlebags are often configured having a base container supported by the motorcycle and a door pivotably attached to the container at one end of the door.

### SUMMARY OF THE INVENTION

The present invention provides, in one aspect, a storage compartment configured to be supported by a vehicle frame. The storage compartment includes a body having an inner surface defining a cavity and an opening for access to the cavity, a door movable between an open position in which the door exposes the opening and a closed position in which the door covers the opening, and a hinge assembly coupling the door and the body. The hinge assembly is enclosed within the cavity when the door is in the closed position. The hinge assembly includes a first four-bar linkage mounted to the body and a second four-bar linkage mounted to the door. The first and second four-bar linkages have at least two unitary links in common.

The present invention provides, in another aspect, a vehicle including a frame, at least one front wheel coupled to a front portion of the frame, at least one rear wheel coupled to a rear portion of the frame, and an engine-transmission assembly supported by the frame between the front and rear wheels. The engine-transmission assembly is operably coupled to the rear wheel. The vehicle also includes a storage compartment coupled to the frame. The storage compartment includes a body having an inner surface defining a cavity and an opening for access to the cavity, a door movable between an open position in which the door exposes the opening and a closed position in which the door covers the opening, and a hinge assembly coupling the door and the body. The hinge assembly is enclosed within the cavity when the door is in the closed position. The hinge assembly includes a first four-bar linkage mounted to the body and a second four-bar linkage mounted to the door. The first and second four-bar linkages have at least two unitary links in common.

Other features and aspects of the invention will become apparent by consideration of the following detailed description and accompanying drawings.

### BRIEF DESCRIPTION OF THE DRAWINGS

FIG. 1 is a side view of a three-wheeled vehicle incorporating a storage compartment embodying the present invention.

FIG. 2 is a rear perspective view of the storage compartment of FIG. 1, illustrating a door of the storage compartment in a closed position.

FIG. 3 is a rear perspective view of the storage compartment of FIG. 1, illustrating the door of the storage compartment in a fully opened position.

FIG. 4 is an exploded, rear perspective view of the door and dual hinge assemblies of the storage compartment of FIG. 1.

FIG. 5 is a perspective view of one of the hinge assemblies of the storage compartment of FIG. 1.

FIG. 6 is a reverse perspective view of the hinge assembly of FIG. 5

FIG. 7 is a cross-sectional view taken along line 7-7 in FIG. 2, illustrating the door in the closed position.

FIG. 8 is a view similar to FIG. 7, illustrating the door in an initial opened position.

FIG. 9 is a view similar to FIG. 7, illustrating the door in a partially-opened position.

FIG. 10 is a view similar to FIG. 7, illustrating the door in an almost fully-opened position.

FIG. 11 is a view similar to FIG. 7, illustrating the door in a fully-opened position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

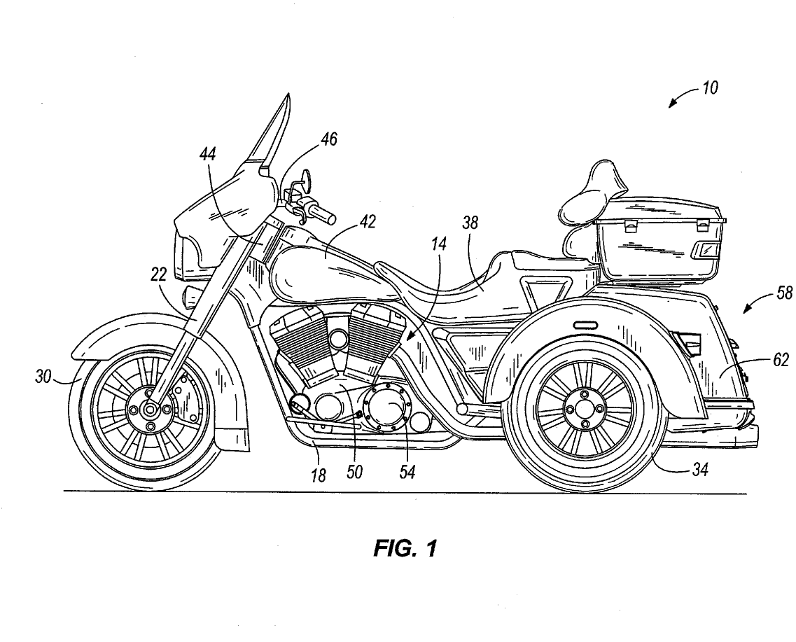

FIG. 1 illustrates a three-wheeled vehicle 10 or “trike” including an engine-transmission assembly 14, a frame 18, a front fork assembly 22, a rear axle assembly (not shown), a front wheel 30, a pair of rear wheels 34 (only one of which is shown), a seat 38, and a fuel tank 42. The frame 18 supports the engine-transmission assembly 14, the front fork assembly 22, the seat 38, and the fuel tank 42. The frame 18 includes a steering head 44 that pivotally supports the front fork assembly 22, which, in turn, supports the front wheel 30. The front fork assembly 22 includes a pair of handlebars 46 for steering the vehicle 10. The rear axle assembly is coupled to the frame 18 at a rear end of the vehicle 10 and rotatably supports the rear wheels 34. The seat 38 is coupled to the frame 18 and is configured for supporting a rider. The fuel tank 42 is supported by the frame 18 and provides fuel to the engine-transmission assembly 14.

The engine-transmission assembly 14 is coupled to the frame 18 beneath the seat 38 between the front wheel 30 and the rear wheels 34 of the vehicle 10. With continued reference to FIG. 1, the engine-transmission assembly 14 includes an engine 50 and a transmission 54, which comprise distinct, independent components of the engine-transmission assembly 14. The engine 50 comprises a V-twin engine 50 supported by the frame 18 forward of the transmission 54. The engine 50 includes an output shaft (not shown), such as a crankshaft, which includes a primary drive sprocket (not shown) for driving a primary chain (not shown) in a conventional manner to power the transmission 54.

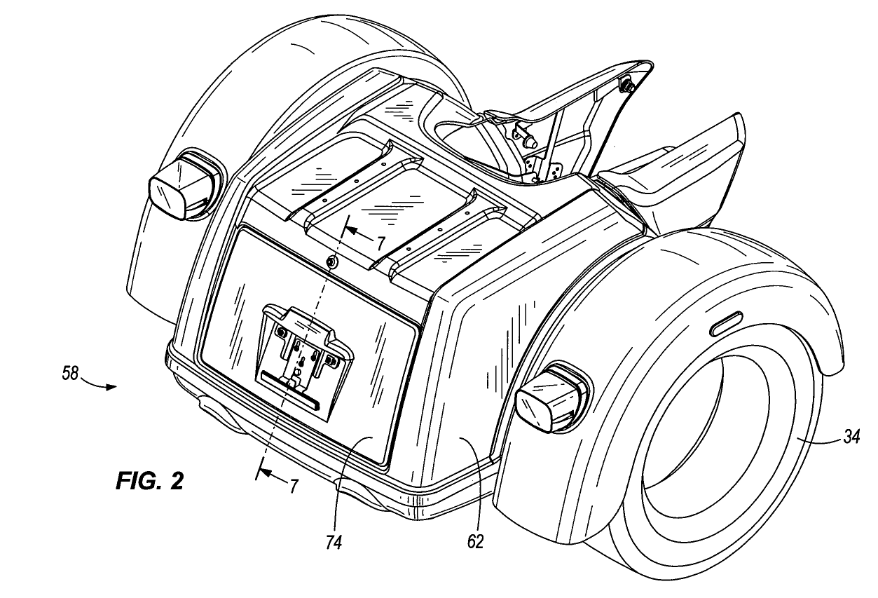

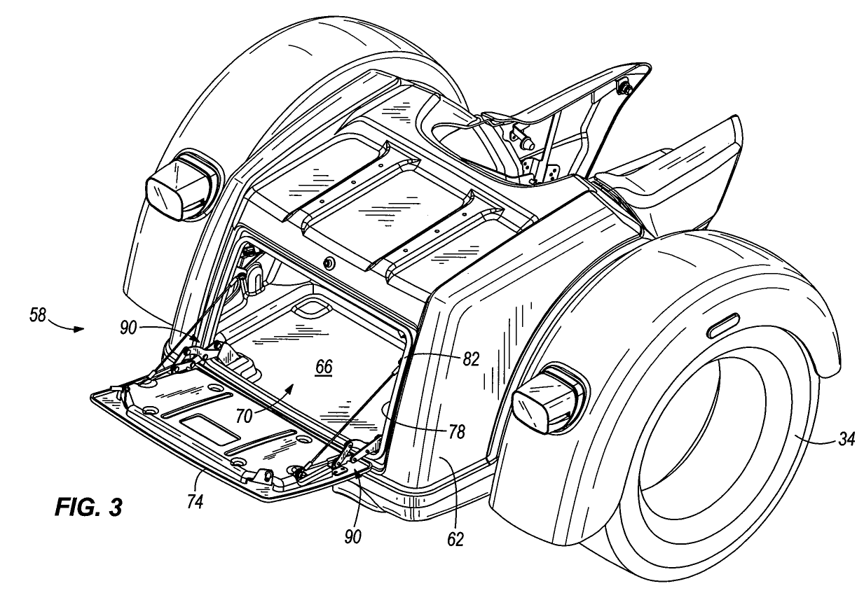

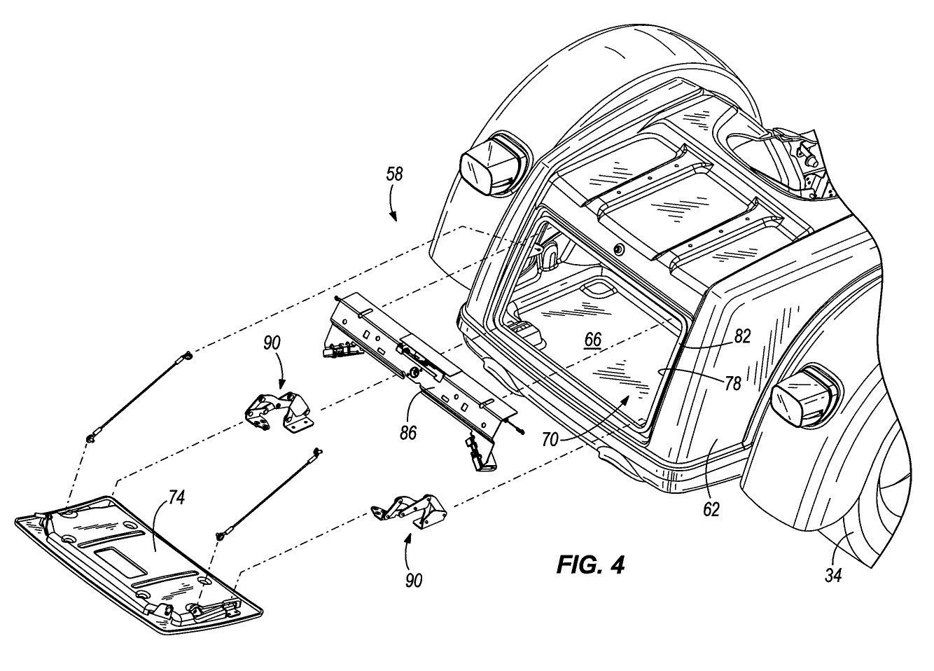

With continued reference to FIG. 1, the vehicle 10 includes a storage compartment 58 coupled to and supported by the frame 18 of the vehicle 10. With reference to FIGS. 2 and 3, the storage compartment 58 includes a body 62 having an interior surface 66 defining a cavity 70, in which vehicle accessories or other items (e.g., clothing, spare parts, removable parts, etc.) may be stored (see FIG. 3). The storage compartment 58 also includes a lid or door 74 that is selectively movable to open and close an opening 78 in the body 62 to selectively allow and prevent access to the cavity 70. In the illustrated construction of the vehicle 10, the storage compartment 58 includes a seal 82 (e.g., an elastomeric or rubber seal) coupled to the body 62 and surrounding the opening 78. Alternatively, the seal 82 may be integrally formed with the body 62 rather than being a separate component coupled to the body 62. The storage compartment 58 further includes a locking assembly 86 that is operable to lock or secure the door 74 in its closed position (see FIG. 4).

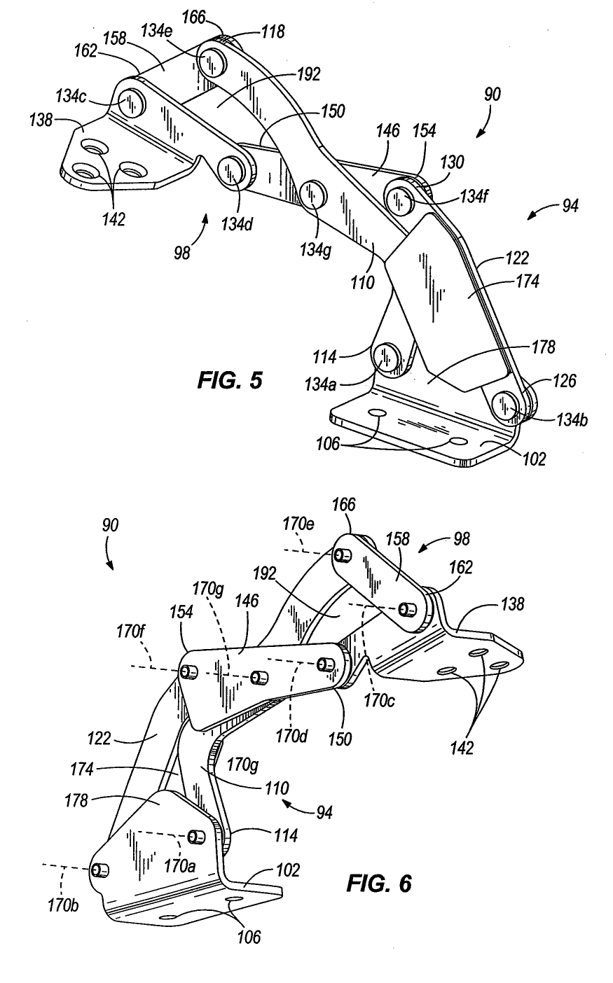

With reference to FIGS. 3 and 4, the storage compartment 58 includes dual hinge assemblies 90 utilized to move the door 74 between its closed and fully-opened positions (see FIGS. 2 and 3, respectively). The hinge assemblies 90 are mounted to the interior surface 66 of the body 62 and, when fully retracted, are positionable entirely within the cavity 70 (see FIG. 2). Each hinge assembly 90 is generally configured as a six-bar linkage. However, each hinge assembly 90 can also be described as including a first four-bar linkage 94 coupled to the body 62 and a second four-bar linkage 98 coupled to the door 74 (see FIGS. 5 and 6). The first four-bar linkage 94 includes a bracket 102 forming the base of the linkage 94. In the illustrated construction of the storage compartment 58, the bracket 102 includes dual apertures 106 through which respective fasteners are received to fasten the hinge assembly 90 to the body 62 of the storage compartment 58. Alternatively, the bracket 102 of each hinge assembly 90 may be coupled to the body 62 in any of a number of different ways (e.g., by clamping, welding, by using adhesives, etc.). As a further alternative, the bracket 102 of each hinge assembly 90 may be integrally formed with the body 62 of the storage compartment 58. With continued reference to FIGS. 5 and 6, the first four-bar linkage 94 further includes a first link 110 having a first end 114 pivotably coupled to the bracket 102 and a second end 118 spaced from the first end 114, and a second link 122 having a first end 126 pivotally coupled to the bracket 102 and a second end 130 spaced from the first end 126. In the illustrated construction of each of the hinge assemblies 90, the respective first ends 114, 126 of the first and second links 110, 122 are pivotably coupled to the bracket 102 by respective rivets 134a, 134b. Alternatively, any of a number of different fasteners (e.g., bolts, etc.) maybe utilized to pivotably couple the first and second links 110, 122 to the bracket 102.

With continued reference to FIGS. 5 and 6, the second four-bar linkage 98 includes a bracket 138 forming the base of the linkage 98. In the illustrated construction of the storage compartment 58, the bracket 138 includes three apertures 142 through which respective fasteners are received to fasten the hinge assembly 90 to the door 74 of the storage compartment 58. Alternatively, the bracket 138 of each hinge assembly 90 may be coupled to the door 74 in any of a number of different ways (e.g., by clamping, welding, by using adhesives, etc.). As a further alternative, the bracket 138 of each hinge assembly 90 may be integrally formed with the door 74. The second four-bar linkage 98 also includes a third link 146 having a first end 150 pivotably coupled to the bracket 138 and a second end 154 spaced from the first end 150, and a fourth link 158 having a first end 162 pivotably coupled to the bracket 138 and a second end 166 spaced from the first end 162. In the illustrated construction of each of the hinge assemblies 90, the respective ends 150, 162 of the third and fourth links 146, 158 are pivotably coupled to the bracket 138 by respective rivets 134c, 134d. Alternatively, any of a number of different fasteners (e.g., bolts, etc.) may be utilized to pivotably couple the third and fourth links 146, 158 to the bracket 138.

With continued reference to FIGS. 5 and 6, the first link 110 is shared by the first and second four-bar linkages 94, 98. In a similar manner, the third link 146 is shared by the first and second four-bar linkages 94, 98. In other words, the link 110 is unitary and in common with the first and second four-bar linkages 94, 98, and the link 146 is unitary and in common with the first and second four-bar linkages 94, 98. Specifically, the respective second ends 118, 166 of the first link 110 and the fourth link 158 are pivotably coupled to each other, and the respective second ends 130, 154 of the second link 122 and the third link 146 are pivotably coupled to each other. In the illustrated construction of each of the hinge assemblies 90, the respective second ends 118, 166 of the first and fourth links 110, 158 are pivotably coupled to each other by a rivet 134e. Likewise, the respective second ends 130, 154 of the second and third links 122, 146 are pivotably coupled to each other by a rivet 134f. Alternatively, any of a number of different fasteners (e.g., bolts, etc.) may be utilized to pivotably couple the first and fourth links 110, 158, and the second and third links 122, 146, respectively.

With reference to FIG. 5, the first and third links 110, 146 are pivotably coupled to each other approximately midway between the respective first and second ends 114, 118 of the first link 110, and approximately midway between the respective first and second ends 150, 154 of the third link 146. In the illustrated construction of each of the hinge assemblies 90, the first and third links 110, 146 are pivotably coupled to each other by a rivet 134g. Alternatively, any of a number of different fasteners (e.g., bolts, etc.) may be utilized to pivotably couple the first and third links 110, 154. The rivets (134a-134g) define respective pivot axes (170a-170g) about which the respective components of each hinge assembly 90 that are interconnected by the rivets (134a-134g) rotate or pivot relative to each other.

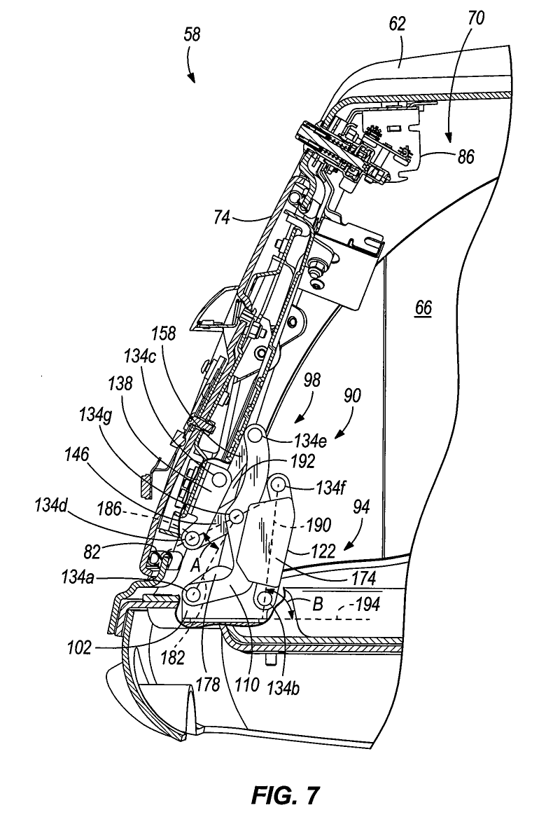

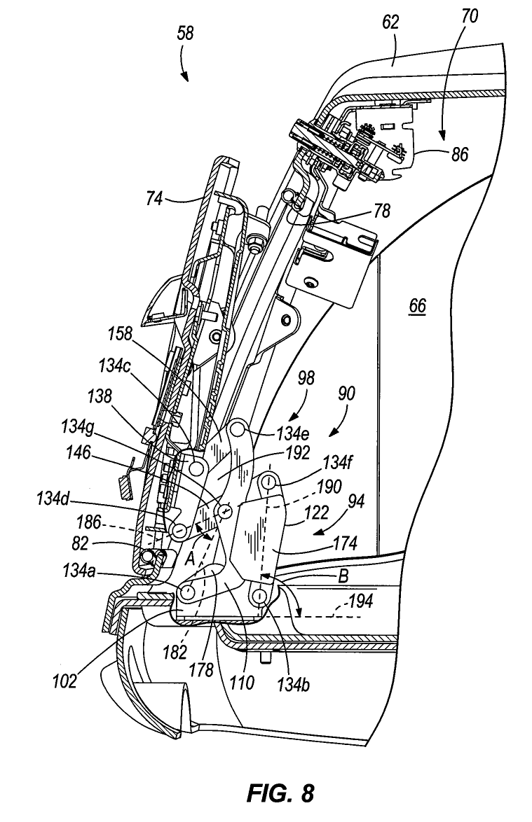

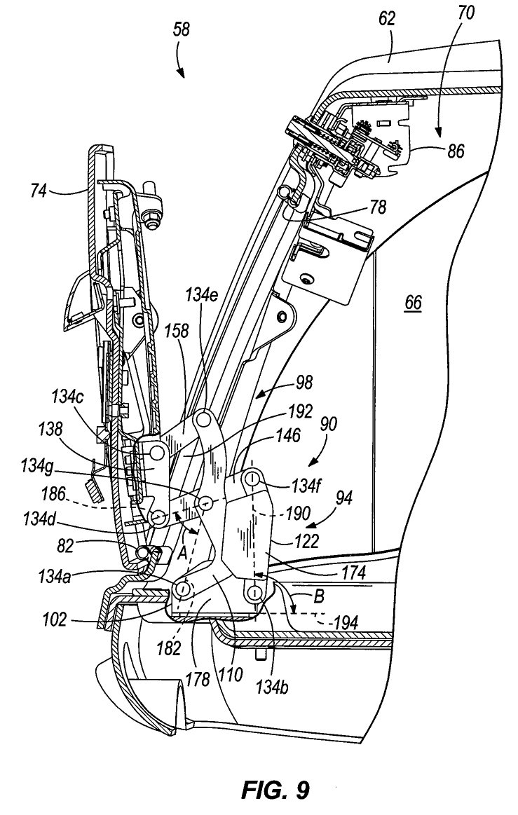

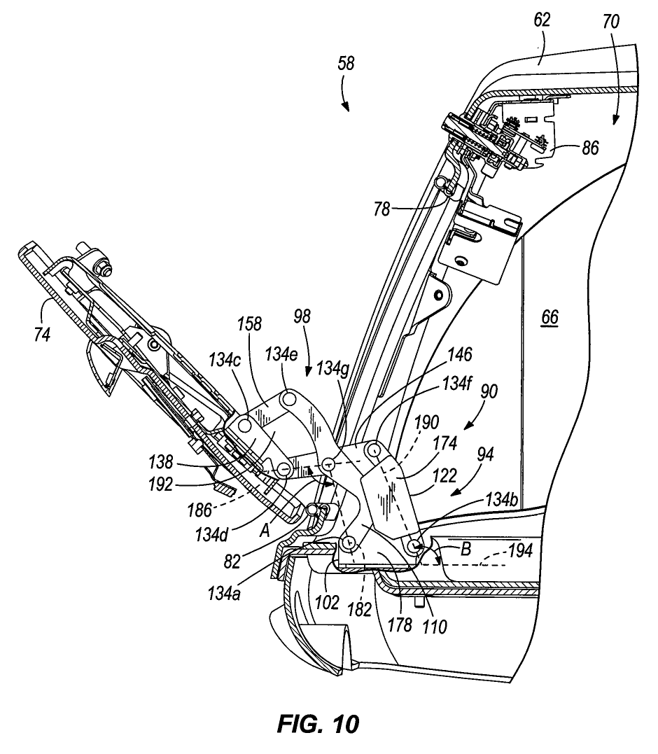

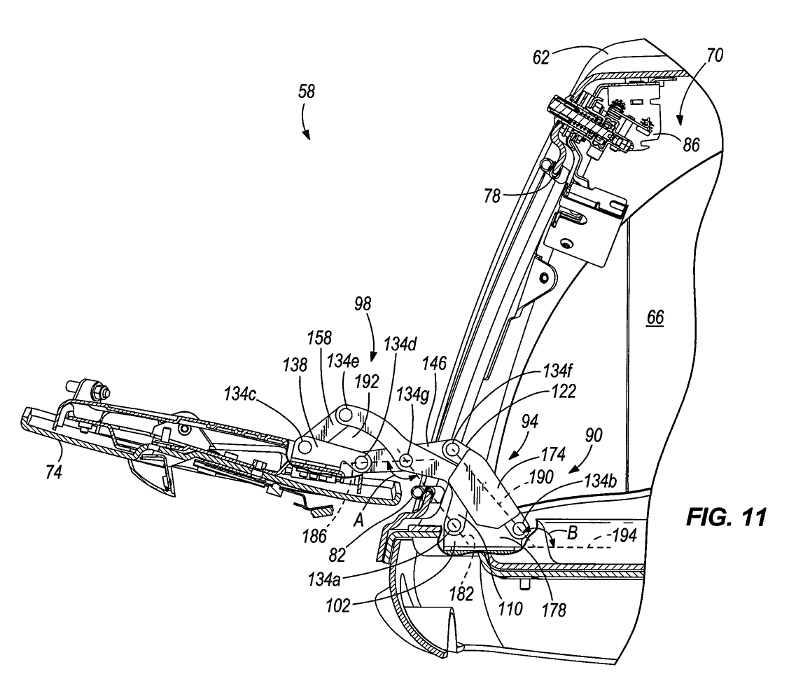

With continued reference to FIG. 5, each of the hinge assemblies 90 includes a shield 174 that extends between the first and second links 110, 122 to at least partially cover the gap or space between the first and second links 110, 122 throughout the range of motion of the first and second links 110, 122 from the door 74 in its closed position to the door 74 in its fully-opened position. In addition, a portion 178 of the bracket 102 at least partially covers the gap or space between the first and second links 110, 122 throughout the range of motion of the first and second links 110, 122 from the door 74 in its closed position to the door 74 in its fully-opened position (see FIG. 6). In the illustrated construction of each of the hinge assemblies 90, the shield 174 is configured as a plate coupled to the second link 122. The shield 174 may be coupled to the second link 122 in any of a number of different ways (e.g., by welding, using adhesives, fastening, etc.). As a further alternative, the shield 174 may be integrally formed with the second link 122. As shown in FIGS. 7-11, a combination of the bracket 102 and the shield 174 substantially covers or overlies the gap or space between the first and second links 110, 122 as the door 74 is moved from its closed position (FIG. 7) to its fully-opened position (FIG. 11) to substantially prevent intentional or inadvertent access to the space or gap between the first and second links 110, 122.

With reference to FIG. 5, the links 110, 138, 146, 158 define a second gap or space 192 that is substantially maintained throughout the range of motion of the links 110, 138, 146, 158 from the door 74 in its closed position to the door 74 in its fully-opened position (see also FIGS. 7-11). In other words, the link 110 is substantially prevented from coming into contact with or engaging the link or bracket 138. Particularly, when the door 74 is in its fully-opened position (see FIG. 11), the contact between the links 110, 122 limits the extent to which the door 74 may be opened and prevents the gap 192 from fully closing.

In operation of the storage compartment 58, the hinge assemblies 90 are configured to impart to the door 74, for at least a portion of the range of motion of the door 74 from its closed position to its fully-opened position, translational motion in addition to rotational motion. The shared links 110, 146 of the first and second four-bar linkages 94, 98 allow each hinge assembly 90 to open and close in a similar manner as a “scissor” linkage. As such, the amount of translation imparted to the door 74 may be referenced with respect to an angle A between a reference line 182 intersecting the pivot axes 134a, 134g and a reference line 186 intersecting the pivot axes 134d, 134g. Furthermore, the change in the angle A (i.e., “ΔA”) relative to the change in an angle B (i.e., “ΔB”), measured between a reference line 190 intersecting the respective pivot axes 134b, 134f and a horizontal plane 194 substantially co-planar with a top surface of the bracket 102, is indicative of the amount of translation imparted to the door 74. For example, a large value of ΔA/ΔB is indicative of a large amount of translation by the door 74 relative to the body 62, while a small value of ΔA/ΔB is indicative of a small amount of translation by the door 74 relative to the body 62. The following table describes the values for angles A and B, respectively, in each position of the hinge assembly 90 shown in FIGS. 7-11:

| | Angle A | Angle B | |
|---|---|---|---|
| Figure No. | (degrees) | (degrees) | ΔA/ΔB |
| 7 | 34 | 85 | |
| 8 | 40 | 86 | 6 |
| 9 | 57 | 92 | 2.83 |
| 10 | 96 | 113 | 1.86 |
| 11 | 124 | 130 | 1.65 |

The values for ΔA/ΔB in the last column of the table are calculated by dividing the change in angle A, from “FIG. N” to “FIG. N-1”, by the change in angle B, from FIG. N to FIG. N-1. For example:

$$\frac{Δ A}{Δ B} = \frac{( 40 - 34 )}{( 86 - 85 )} = 6$$

In the illustrated construction of the storage compartment 58, most of the translation imparted to the door 74, throughout the range of motion of the door 74 from its closed position to its fully-opened position, occurs within 7 degrees of rotation of the second link 122 (i.e., of angle B, from about 85 degrees to about 92 degrees) from its initial position shown in FIG. 7. As a result, the door 74 is allowed to disengage the seal 82, along its entire length around the periphery of the opening 78, before the motion of the door 74 is converted substantially to rotation. As a result, a tighter seal between the door 74 and the body 62 is promoted because progressive sealing of the door 74 against the seal 82, which may yield uneven wear along the length of the seal 82, is reduced.

Although the storage compartment 58 is shown incorporated with a three-wheeled vehicle 10 or trike, the storage compartment 58 may also be configured as a saddlebag incorporated or attached to a two-wheeled vehicle (i.e., a motorcycle).

Various features of the invention are set forth in the following claims.

1. A storage compartment configured to be supported by a vehicle frame, the storage compartment comprising:
a body having an inner surface defining a cavity and an opening for access to the cavity;
a door movable between a fully open position in which the door exposes the opening and a closed position in which the door covers the opening;
a hinge assembly coupling the door and the body, the hinge assembly enclosed within the cavity when the door is in the closed position, the hinge assembly including
a first four-bar linkage including a first link pivotably coupled to the body and a second link pivotably coupled to the body; and
a second four-bar linkage mounted to the door, the first and second four-bar linkages having the first link and at least one additional unitary link in common;
wherein the second link is pivotable about 45 degrees or less when moving the door between the closed position and the fully open position.

2. (canceled)

3. The storage compartment of claim 1, wherein the first and second links define a gap therebetween when the door is in the fully open position, and wherein the hinge assembly further includes a shield positioned adjacent the first and second links to substantially cover the gap when the door is in the fully open position.

4. The storage compartment of claim 3, wherein the shield comprises a plate coupled to one of the first and second links.

5. (canceled)

6. The storage compartment of claim 1, wherein the second four-bar linkage includes a third link pivotably coupled to the door and a fourth link pivotably coupled to the door, and wherein one of the third and fourth links comprises the at least one additional unitary link.

7. The storage compartment of claim 6, wherein the first link includes a first end and a second end, wherein the first end of the first link is pivotably coupled to the body, and wherein the second end of the first link is pivotably coupled to the fourth link.

8. The storage compartment of claim 7, wherein the third link includes a first end and a second end, wherein the first end of the third link is pivotably coupled to the door, wherein the second end of the third link is pivotably coupled to the second link such that the third link comprises the at least one additional unitary link, wherein the first link is pivotably coupled to the third link between the first end and the second end of the first link, and wherein the third link is pivotably coupled to the first link between the first end and the second end of the third link.

9. The storage compartment of claim 6, wherein the third link includes a first end and a second end, wherein the first end of the third link is pivotably coupled to the door, and wherein the second end of the third link is pivotably coupled to the second link such that the third link comprises the at least one additional unitary link.

10. The storage compartment of claim 1, wherein the body includes an exterior surface through which the opening is formed, and wherein the hinge assembly guides the door through substantially translational motion at least until the door substantially disengages the body, after which the hinge assembly imparts substantially rotational motion to the door.

11. A vehicle comprising:
a frame;
at least one front wheel coupled to a front portion of the frame;
at least one rear wheel coupled to a rear portion of the frame;
an engine-transmission assembly supported by the frame between the front and rear wheels, the engine-transmission assembly operably coupled to the rear wheel; and
a storage compartment coupled to the frame, the storage compartment including
a body having an inner surface defining a cavity and an opening for access to the cavity,
a door movable between a fully open position in which the door exposes the opening and a closed position in which the door covers the opening, and
a hinge assembly coupling the door and the body, the hinge assembly enclosed within the cavity when the door is in the closed position, the hinge assembly including
a first four-bar linkage including a first link pivotably coupled to the body and a second link pivotably coupled to the body, and
a second four-bar linkage mounted to the door, the first and second four-bar linkages having the first link and at least one additional unitary link in common;
wherein the second link is pivotable about 45 degrees or less when moving the door between the closed position and the fully open position.

12. (canceled)

13. The vehicle of claim 11, wherein the first and second links define a gap therebetween when the door is in the fully open position, and wherein the hinge assembly further includes a shield positioned adjacent the first and second links to substantially cover the gap when the door is in the fully open position.

14. The vehicle of claim 13, wherein the shield comprises a plate coupled to one of the first and second links.

15. (canceled)

16. The vehicle of claim 11, wherein the second four-bar linkage includes a third link pivotably coupled to the door and a fourth link pivotably coupled to the door, and wherein one of the third and fourth links comprises the at least one additional unitary link.

17. The vehicle of claim 16, wherein the first link includes a first end and a second end, wherein the first end of the first link is pivotably coupled to the body, and wherein the second end of the first link is pivotably coupled to the fourth link.

18. The vehicle of claim 17, wherein the third link includes a first end and a second end, wherein the first end of the third link is pivotably coupled to the door, wherein the second end of the third link is pivotably coupled to the second link such that the third link comprises the at least additional unitary link, wherein the first link is pivotably coupled to the third link between the first end and the second end of the first link, and wherein the third link is pivotably coupled to the first link between the first end and the second end of the third link.

19. The vehicle of claim 16, wherein the third link includes a first end and a second end, wherein the first end of the third link is pivotably coupled to the door, and wherein the second end of the third link is pivotably coupled to the second link such that the third link comprises the at least one additional unitary link.

20. The vehicle of claim 11, wherein the body includes an exterior surface through which the opening is formed, and wherein the hinge assembly guides the door through substantially translational motion at least until the door substantially disengages the body, after which the hinge assembly imparts substantially rotational motion to the door.

21. The storage compartment of claim 8, wherein the first and third links are pivotably coupled about a common pivot axis, wherein the hinge assembly defines
a first reference line perpendicular to the pivot axis and extending toward the first end of the first link, and
a second reference line perpendicular to the pivot axis and extending toward the first end of the third link, and wherein an included angle between the first and second reference lines continuously increases from a first value coinciding with the closed position of the door to a second value coinciding with the fully open position of the door.

22. The storage compartment of claim 21, wherein the included angle between the first and second reference lines continuously increases by about 90 degrees when the door is moved from the closed position to the fully open position.

23. The storage compartment of claim 1, wherein the first and second links contact each other when the door is moved to the fully open position.

24. The vehicle of claim 18, wherein the first and third links are pivotably coupled about a common pivot axis, wherein the hinge assembly defines
a first reference line perpendicular to the pivot axis and extending toward the first end of the first link, and
a second reference line perpendicular to the pivot axis and extending toward the first end of the third link, and wherein an included angle between the first and second reference lines continuously increases from a first value coinciding with the closed position of the door to a second value coinciding with the fully open position of the door.

25. The vehicle of claim 24, wherein the included angle between the first and second reference lines continuously increases by about 90 degrees when the door is moved from the closed position to the frilly open position.

26. The vehicle of claim 11, wherein the first and second links contact each other when the door is moved to the fully open position.
